(19) United States
(12) Patent Application Publication
(10) Pub. No.: US 2025/0332806 A1
(43) Pub. Date: Oct. 30, 2025

(54) BUFFER FORMING MACHINE

(71) Applicant: Jui-Chun CHANG, Sugar Land, TX (US)

(72) Inventors: Jui-Chun CHANG, Sugar Land, TX (US); Wei-Wen PENG, Sugar Land, TX (US); Chih-Cheng LIU, Taichung City (TW); Fu-Wang HSIAO, Taichung City (TW)

(21) Appl. No.: 19/189,794

(22) Filed: Apr. 25, 2025

Related U.S. Application Data
(60) Provisional application No. 63/639,288, filed on Apr. 26, 2024.
(60) Provisional application No. 63/714,292, filed on Oct. 31, 2024.

(51) Int. Cl. B31D 3/02

(52) U.S. Cl. CPC B31D 3/0223

(57) ABSTRACT

A buffer forming machine includes a frame and a roller unit. The roller unit includes at least two friction wheel sets spaced apart from each other, one of the at least two friction wheel sets defining a feed region, another one of the at least two friction wheel sets defining an output region. A ratio of a height of the output region in the height direction to a height of the feed region in the height direction is greater than 70%. The height of the feed region in the height direction is configured to be 90-95% of a height of each of the plurality of sheet materials in the height direction. The height of the output region in the height direction is configured to be 70-75% of the height of each of the plurality of the sheet materials.

### CROSS-REFERENCE TO RELATED APPLICATION

This application claims the benefit of U.S. Provisional Patent Application No. 63/639288, filed on Apr. 26, 2024, and U.S. Provisional Patent Application No. 63/714,292, filed on Oct. 31, 2024, the entire disclosure of which is incorporated by reference herein.

### FIELD

The disclosure relates to buffer packaging material forming equipment, and more particularly to a buffer forming machine.

### BACKGROUND

A buffer is disposed in a box to act as a cushion for items contained in the box; in other words, the buffer prevents the items from being damaged by impact during shipping. In recent years, the logistics industry has been rapidly developing, and logistics-related industries, such as manufacture of the buffering packaging materials, have also been prospering.

Currently, two types of conventional buffers are commonly used: inflatable plastic buffers, and honeycomb core buffers. Since environmental issues are becoming more prominent, buffers with reduced plastic are bound to be the focus for future development.

In recent years, since paper is more suitable for environmental needs in terms of degradation and decomposition, conventional buffers made of paper are widely used.

U.S. Pat. No. 6,871,480 discloses a packaging wrap that includes a folded layer disposed between two flat sheet materials that can be continuously unfurled. A top portion and a bottom portion of the folded layer each have a plurality of end edges that are adhered to the flat sheet materials.

U.S. Pat. No. 9,649,823 discloses a packaging material that includes a core portion and at least one liner. The core portion has a plurality of walls. The walls form three-dimensional geometric patterned structures. The three-dimensional geometric patterned structures define air spaces and reinforce structural strength of the packaging material.

It can be noted from the disclosures of the abovementioned prior art that, even though expandable buffers are widely used in packaging gradually, the conventional buffers still do not deviate from the corrugated paper form, which is formed by bonding flat sheet materials to folded parts.

Essentially, in a completely formed conventional buffer, a solid part of the conventional buffer only takes up 5-20% of the total volume, and the remaining volume is expansion space. Therefore, the conventional buffer causes significant hurdles and high cost in shipping; moreover, in comparison to plastic buffers, buffers made of paper further have the problem of high manufacturing cost, which is disadvantageous to the development thereof.

A conventional buffer forming approach includes the following steps: (1) folding an expansion portion to form a folded portion, and (2) bonding at least one flat sheet material to the folded portion to secure the folds in place. The buffers respectively disclosed in U.S. Pat. No. 6,871,480 and U.S. Pat. No. 9,649,823 require the folded portions (i.e., the folded layer in U.S. Pat. No. 6,871,480, and the core portion in U.S. Pat. No. 9,649,823) to be secured in place before the buffers are transported, which causes problems in shipping cost. Chinese Invention Patent Application Publication No. 115593796A discloses a

shockproof honeycomb paper pad structure and a manufacturing approach thereof. The manufacturing approach includes the following steps: first expanding shockproof latticed paper pads into hexagonal paper strips, spacing the hexagonal paper strips evenly apart, adhering the hexagonal paper strips together to form shockproof honeycomb paper pads, and in a state where tensile strain remains constant, making the shockproof honeycomb paper pads enter an inverted scraper. After the honeycomb paper pads enter the inverted scraper, both top and bottom ends of the stretched hexagonal paper strips are deformed and bent towards a side. After the deformed shockproof latticed paper pads are transferred to a pair of rollers that has a designed gap to conduct shape rolling, a shockproof honeycomb paper pad that has a designed thickness is formed. At this time, both the top and bottom ends of the hexagonal paper strips form folds at non-adhered areas, and middle portions of adhered areas are bent.

The abovementioned manufacturing approach has some problems. The stretched hexagonal paper strips actually have different stiffness existing in the non-adhered areas and the adhered areas, and folds are formed at both the top and bottom ends of the non-adhered areas through the inverted scrapers. Since each of the adhered areas is formed by adhering two paper strips, stiffness is high, and the stretched hexagonal paper strips are not easy to deform directly through the inverted scrapers. Therefore, the stretched hexagonal paper strips are then subjected to shape rolling through a pair of rollers that has a gap therebetween with a pre-set height.

The pre-set height of the gap is 30-50% of a height of each of the hexagonal paper strips so that the pair of rollers can overcome the stiffness of the adhered areas to shape the hexagonal paper strips during shape rolling. However, this also severely decreases a buffering effect of the shockproof honeycomb paper pad structure. Furthermore, each of the hexagonal paper strips is compressed to 50-65% of an original height thereof for more stable shaping, which causes the middle portions to bend. Bending the middle portions of the hexagonal paper strips is equivalent to deforming the hexagonal paper strips by direct compression, which will overly decrease its buffering effect. Speed and output steadiness for manufacturing the shockproof honeycomb paper pad structure will also be severely affected.

Moreover, since the hexagonal paper strips are bent through significant compression, the bent hexagonal paper strips vary in height, which causes the shockproof honeycomb paper pad structure to have an uneven surface easily.

In conclusion, in the approaches that use honeycomb cores as packaging materials, the approaches having the step of continuous expansion shaping are important. These approaches save high-cost shipping fees, and are advantageous to environmentally friendly reuse. However, how to simultaneously keep the middle of the paper strips from bending as much as possible to maintain a preferred buffering effect, and have a smooth and fast continuous production while the honeycomb cores are shaped and expanded, is a problem that needs to be solved urgently.

### SUMMARY

Therefore, an object of the disclosure is to provide a buffer forming machine that can alleviate at least one of the drawbacks of the prior art.

According to the disclosure, the buffer forming machine is adapted for continuously pressing and conveying a honeycomb core in a stretching direction through a feed stage, a shaping stage and a rebound stage to turn the honeycomb core into a buffer. The honeycomb core includes a plurality of sheet materials that are elongated in a widthwise direction perpendicular to the stretching direction, and that are arranged in the stretching direction. Each of the plurality of sheet materials has a plurality of bonded portions and a plurality of unbonded portions that are alternately arranged in the widthwise direction. For each three adjacent ones of the plurality of sheet materials, the plurality of bonded portions of the middle sheet material are alternately bonded to the plurality of bonded portions of another sheet material and the plurality of bonded portions of the remaining sheet material. Each junction of two bonded portions of two adjacent ones of the plurality of sheet materials form a thick surrounding wall. The buffer forming machine includes a frame and a roller unit. The roller unit is mounted to the frame, and includes at least two friction wheel sets spaced apart from each other in the stretching direction. One of the at least two friction wheel sets includes a first upper rolling friction wheel and a first lower rolling friction wheel that are arranged in a height direction perpendicular to the widthwise direction and the stretching direction. The first upper rolling friction wheel and the first lower rolling friction wheel cooperatively define a feed region therebetween. Another one of the at least two friction wheel sets includes a second upper rolling friction wheel and a second lower rolling friction wheel that are arranged in the height direction. The second upper rolling friction wheel and the second lower rolling friction wheel cooperatively define an output region therebetween. A ratio of a height of the output region in the height direction to a height of the feed region in the height direction is greater than 70%. The height of the feed region in the height direction is configured to be 90-95% of a height of each of the plurality of sheet materials in the height direction. The height of the output region in the height direction is configured to be 70-75% of the height of each of the plurality of the sheet materials.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a side view illustrating an embodiment of a buffer forming machine according to the disclosure.

FIG. 2 is a schematic perspective view illustrating a honeycomb core being expanded in a stretching direction.

FIG. 3 is a fragmentary schematic view, illustrating a buffer.

FIG. 4 is a fragmentary enlarged view of FIG. 3.

FIG. 5 is a sectional view taken along line V-V in FIG. 4.

FIG. 6 is a sectional view taken along line VI-VI in FIG. 4.

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

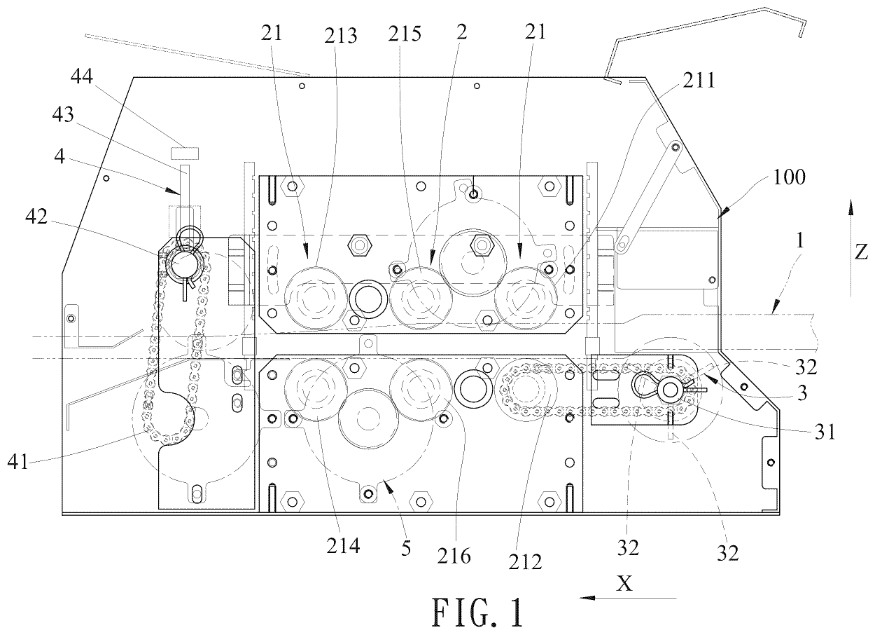

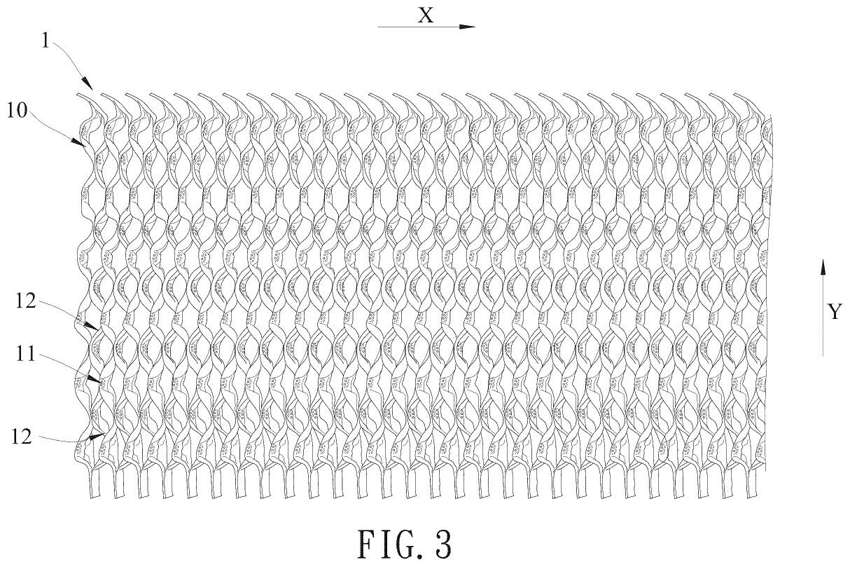

Referring to FIGS. 1 to 4, an embodiment of a buffer forming machine according to the disclosure is adapted for turning a honeycomb core 1 into a buffer.

The buffer forming machine includes a frame 100, a roller unit 2, a feeder unit 3, a tear unit 4, and a driver unit 5. The roller unit 2 and the feeder unit 3 are adapted for continuously pressing and conveying the honeycomb core 1 in a stretching direction (X) through a feed stage, a shaping stage and a rebound stage to turn the honeycomb core 1 into a buffer.

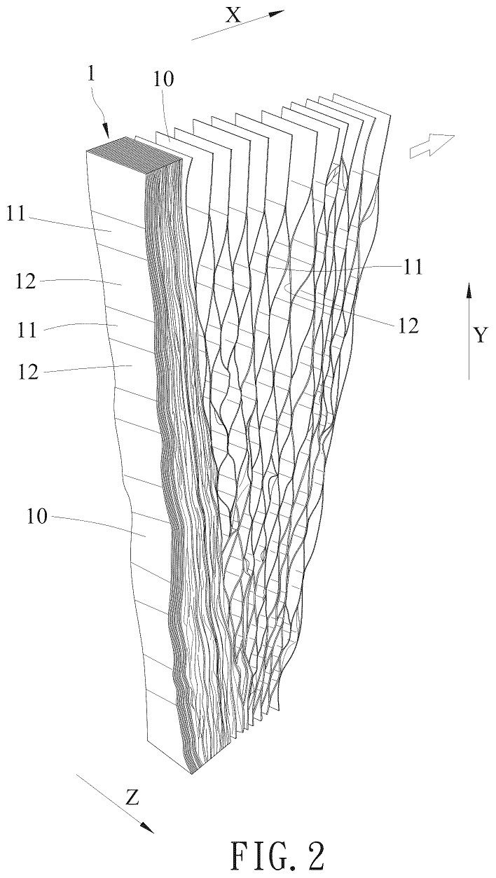

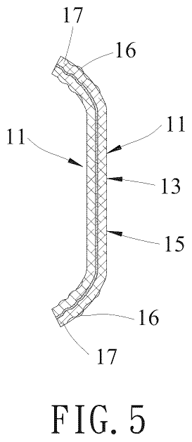

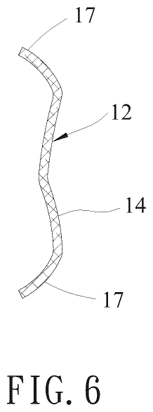

Referring to FIGS. 2 and 6, the honeycomb core 1 includes a plurality of sheet materials 10 that are elongated in a widthwise direction (Y) perpendicular to the stretching direction (X), and that are arranged in the stretching direction (X). Each of the sheet materials 10 has a plurality of bonded portions 11 and a plurality of unbonded portions 12 that are alternately arranged in the widthwise direction (Y). For each three adjacent ones of the sheet materials 10, the bonded portions 11 of the middle sheet material 10 are alternately bonded to the bonded portions 11 of another sheet material 10 and the bonded portions 11 of the remaining sheet material 10. Each junction of two bonded portions 11 of two adjacent ones of the sheet materials 10 forms a thick surrounding wall 15 (see FIG. 5). Heights of the sheet materials 10 in a height direction (Z) perpendicular to the stretching direction (X) and the widthwise direction (Y) are substantially the same. In this embodiment, each two bonded portions 11 of two adjacent ones of the sheet materials 10 are bonded by glue or an adhesive. In other embodiments, the bonded portions 11 may be bonded through stapling. Since the bonding method of the bonded portions 11 is well known in the art, further description thereof will be omitted for the sake of brevity.

The sheet materials 10 are made of an environmentally friendly material like a recyclable fiber, or a biodegradable material. In some embodiments, the sheet materials 10 are made of recycled paper that has a grammage of 80-200 g/m². Each of the sheet materials 10 has a thickness of 0.08-0.2 mm. A length of each of the sheet materials 10 in the widthwise direction (Y) is 10-80 cm, and a height of each of the sheet materials 10 in the height direction (Z) is 1-6 cm. A length of each of the unbonded portions 12 in the widthwise direction (Y) is 0.5-5 cm. In this embodiment, the sheet materials 10 are made of recycled paper that has a grammage of 120 g/m², and each has a thickness of 0.12 mm. In this embodiment, the length of each of the sheet materials 10 in the widthwise direction (Y) is 30 cm, the length of each of the sheet materials 10 in the height direction (Z) is 2 cm, the length of each of the unbonded portions 12 in the widthwise direction (Y) is 2 cm, and a length of each of the bonded portions 11 in the widthwise direction (Y) is 0.9 cm.

The feeder unit 3 is mounted to the frame 100, is disposed upstream of the roller unit 2 in the stretching direction (X), and includes a rotary wheel 31, and a plurality of levers 32 that are mounted to the rotary wheel 31 and that are spaced apart from each other. After two adjacent sheet materials 10 (specifically, the first sheet material 10 of the honeycomb core 1 in the stretching direction (X) and the sheet material 10 adjacent to the first sheet material 10) are pulled apart in the stretching direction (X), and the honeycomb core 1 is hooked onto the levers 32, the feeder unit 3 is activated to drive the rotary wheel 31 and the levers 32 to rotate such that each of the plurality of levers 32 is adapted to be inserted between a corresponding adjacent pair of the plurality of sheet materials 10 to draw the honeycomb core 1 in the stretching direction (X) into the roller unit 2 for the roller unit 2 to conduct pressing and conveying of the honeycomb core 1.

The roller unit 2 is mounted to the frame 100, and includes at least two friction wheel sets 21 spaced apart from each other in the stretching direction (X). One of the at least two friction wheel sets 21 includes a first upper rolling friction wheel 211 and a first lower rolling friction wheel 212 that are arranged in the height direction (Z). The first upper rolling friction wheel 211 and the first lower rolling friction wheel 212 cooperatively define a feed region therebetween. A height of the feed region in the height direction (Z) is 1.9 cm. In the feed stage, when the honeycomb core 1 is passing through the feed region, the first upper rolling friction wheel 211 and the first lower rolling friction wheel 212 respectively press against a top portion and a bottom portion of each of the sheet materials 10 so that when the first upper rolling friction wheel 211 and the first lower rolling friction wheel 212 are rotating, the sheet materials 10 are pressed and conveyed through the feed region. The first upper rolling friction wheel 211 and the first lower rolling friction wheel 212 press and covey the sheet materials 10 with friction. At this time, the sheet materials 10 are pressed and shaped by the first upper rolling friction wheel 211 and the first lower rolling friction wheel 212 to form a plurality of hexagonal honeycomb bodies; specifically, for every two adjacent ones of the sheet materials 10, the thick surrounding walls 15 and the unbonded portions 12 form a plurality of hexagonal honeycomb bodies. For each of the hexagonal honeycomb bodies, the hexagonal honeycomb body consists of four unbonded portions 12 that have the same size in the widthwise direction (Y) and that are configured as four faces of the hexagonal honeycomb body, and two thick surrounding walls 15 that have the same size in the widthwise direction (Y) and that are configured as another two faces of the hexagonal honeycomb body. In other embodiments, the size of each of the thick surrounding walls 15 in the widthwise direction (Y) is no bigger than 60% of the size of each of the unbonded portions 12 in the widthwise direction (Y). In this embodiment, the size of each of the thick surrounding walls 15 in the widthwise direction (Y) is 10-45% of the size of each of the unbonded portions 12 in the widthwise direction (Y). Since the bonded portions 11 are bonded through glue or an adhesive, when the honeycomb core 1 is expanded, the bonded portions 11 may receive different magnitudes of forces. Therefore, there may be tolerances of 3-5% of the lengths of the bonded portions 11. In this embodiment, a ratio of the length of each of the bonded portions 11 in the widthwise direction (Y) to the length of each of the unbonded portions 12 in the widthwise direction (Y) is 25-30%.

The tear unit 4 is mounted to the frame 100, is disposed at a side of the roller unit 2, and includes a tear member 41, a rotary shaft 42, a plurality of insertion rods 43 that are fixed to the rotary shaft 42 (only one insertion rod 43 can be seen in FIG. 1 due to the viewing angle), and a sensor 44 that is mounted to the frame 100 and disposed above the rotary shaft 42. The sensor 44 is operable for sensing whether the insertion rods 43 obstruct output of the honeycomb core 1 from the output region. In this embodiment, the tear unit 4 is disposed downstream of the roller unit 2 in the stretching direction (X). In other embodiments, the tear unit 4 may be disposed between the roller unit 2 and the feeder unit 3. The tear member 41 is operable for driving the rotary shaft 42 to rotate, which in turn drives each of the insertion rods 43 to move for insertion between a corresponding adjacent pair of the sheet materials 10 to tear the honeycomb core 1 when the honeycomb core 1 is being conveyed in the stretching direction (X).

The driver unit 5 is mounted to the frame 100, and is operable for driving the friction wheel sets 21 and the rotary wheel 31 to rotate.

In this embodiment, the honeycomb core 1 is drawn into the feed region by the feeder unit 3. In other embodiments, the feeder unit 3 may be omitted and a user can directly place the honeycomb core 1 into the feed region to press and convey the honeycomb core 1 through the first upper rolling friction wheel 211 and the first lower rolling friction wheel 212 as well, but with increased danger.

An expansion degree of the honeycomb core 1 is controlled. Specifically, the honeycomb core 1 is made to reach a certain level of expansion before being drawn into the feed region by providing a resistance force applied on the honeycomb core 1. An approach of providing the resistance force is to create a height discrepancy between a starting position of the honeycomb core 1 and the feed region in the height direction (Z); in other words, the staring position is positioned lower than the feed region so that the honeycomb core 1 is expanded by gravity before being drawn into the feed region. Another approach is to position the starting position at substantially the same height as the feed region, and dispose a resistance roller on top of or below the honeycomb core 1 to resist movement of the honeycomb core 1. By adjusting the resistance provided by the resistance roller, the honeycomb core 1 expands up to 20-100 times in size before entering the feed region.

Furthermore, surfaces of both the first upper rolling friction wheel 211 and the first lower rolling friction wheel 212 are coarse. At the feed stage, since the height of the feed region is adapted to be smaller than the height of each of the sheet materials 10, the first upper rolling friction wheel 211 and the first lower rolling friction wheel 212 are adapted for clamping the honeycomb core 1. Since the surfaces of the first upper rolling friction wheel 211 and the first lower rolling friction wheel 212 are coarse, friction is generated between the first upper rolling friction wheel 211, the first lower rolling friction wheel 212, and the honeycomb core 1 so that the honeycomb core 1 is drawn into the feed region by friction. The first upper rolling friction wheel 211 and the first lower rolling friction wheel 212 only need to press the top portions and the bottom portions of the sheet materials 10 to convey the honeycomb core 1 in the stretching direction (X), which decreases overall compression of the sheet materials 10. Referring to FIG. 5, each of the thick surrounding walls 15 has an intermediate portion 13 that is elongated in the height direction (Z). When the honeycomb core 1 has passed through the feed region, an average deformation degree of the intermediate portions 13 of the honeycomb core 1 is less than 10% of that of the intermediate portions 13 of the honeycomb core 1 that has not passed through the feed region. Hence, the average deformation degree of the intermediate portions 13 is controlled, and at the same time, impact resistance of the hexagonal honeycomb bodies is not decreased.

A discrepancy between the height of the feed region and the height of each of the sheet materials 10 in the height direction (Z) is not over 30% of the height of each of the sheet materials 10 in the height direction (Z); that is to say, if the height of the feed region is smaller than 1.4 cm, the intermediate portions 13 may be severely deformed when being pressed and conveyed through the feed region, which decreases a buffering effect of the buffer formed by the buffer forming machine of the disclosure. In other words, the height of the feed region is configured to be greater than 70% of the height of each of the sheet materials 10. Furthermore, since the surfaces of the first upper rolling friction wheel 211 and the first lower rolling friction wheel 212 are coarse, the honeycomb core 1 is drawn by friction. At this time, the first upper rolling friction wheel 211 and the first lower rolling friction wheel 212 respectively bend the top portion and the bottom portion of each of the sheet materials 10 with minimal effects on the structure of the intermediate portion 13. The height of the feed region in the height direction (Z) is configured to be 90-95% of the height of each of the plurality of sheet materials 10 in the height direction (Z), which is 1.8-1.9 cm. Since each of the thick surrounding walls 15 is formed from a junction of two bonded portions 11 of two adjacent ones of the plurality of sheet materials 10, a thickness of each of the thick surrounding walls 15 is bigger than 2 times a thickness of each of the unbonded portions 12. The stiffness of each of the thick surrounding walls 15 is bigger than 2 times the stiffness of each of the unbonded portions 12. For each of the hexagonal honeycomb bodies, if the size of each of the thick surrounding walls 15 in the widthwise direction (Y) is bigger than 60% of the size of each of the unbonded portions 12 in the widthwise direction (Y), the thick surrounding walls 15 will have high stiffness, and more force will be needed to form folds on the thick surrounding walls 15, which may cause the intermediate portions 13 to deform.

Another one of the at least two friction wheel sets 21 includes a second upper rolling friction wheel 213 and a second lower rolling friction wheel 214 that are arranged in the height direction (Z), and that are rotatable. The second upper rolling friction wheel 213 and the second lower rolling friction wheel 214 cooperatively define an output region therebetween. A height of the output region in the height direction (Z) is 1.4 cm. A ratio of the height of the output region in the height direction (Z) to the height of the feed region in the height direction (Z) is greater than 70%. Surfaces of both the second upper rolling friction wheel 213 and the second lower rolling friction wheel 214 are coarse. At the shaping stage, the second upper rolling friction wheel 213 and the second lower rolling friction wheel 214 rotate and clamp the honeycomb core 1 that has been slightly deformed, and then the honeycomb core 1 is drawn in the stretching direction (X) and transferred into the output region by friction generated between the second upper rolling friction wheel 213, the second lower rolling friction wheel 214, and the honeycomb core 1, thereby causing the top portions and the bottom portions of the sheet materials 10 to be further bent.

In this embodiment, the height of the output region is reduced compared to the height of the feed region. A ratio of the reduction is not greater than 30% of the height of the feed region. The height of the feed region in the height direction (Z) is 1.9 cm, and the height of the output region in the height direction (Z) is 1.4 cm. By virtue of the configurations of the second upper rolling friction wheel 213 and the second lower rolling friction wheel 214, when the honeycomb core 1 passes through the output region, the average deformation degree of the intermediate portions 13 of the honeycomb core 1 is less than 10% of that of the intermediate portions 13 of the honeycomb core 1 that has not passed through the output region; in other words, the impact resistance of the hexagonal honeycomb bodies is not affected, and the buffering effect of the buffer formed by the buffer forming machine of the disclosure is also not affected. In this embodiment, the height of the output region is bigger than 60% of the height of each of the sheet materials 10, thereby lowering chances of the intermediate portions 13 being directly bent.

In this embodiment, there is an auxiliary pushing and conveying stage between the feed stage and the shaping stage. The roller unit 2 further includes an auxiliary friction wheel set. The auxiliary friction wheel set includes an auxiliary upper rolling friction wheel 215 disposed between the first upper rolling friction wheel 211 and the second upper rolling friction wheel 213, and an auxiliary lower rolling friction wheel 216 disposed between the first lower rolling friction wheel 212 and the second lower rolling friction wheel 214. The auxiliary upper rolling friction wheel 215 and the auxiliary lower rolling friction wheel 216 are arranged in the height direction (Z), and are rotatable. The auxiliary upper rolling friction wheel 215 and the auxiliary lower rolling friction wheel 216 cooperatively define an auxiliary region therebetween. The auxiliary region is disposed between the feed region and the output region, and compared to an embodiment without the auxiliary region, the pressing and conveying process of the honeycomb core 1 is steadier. In this embodiment, a height of the auxiliary region in the height direction (Z) is 1.7 cm. The height of the auxiliary region is smaller than the height of the feed region and larger than the height of the output region. The honeycomb core 1 is first pressed and conveyed through the feed region, whose height is configured to be smaller than the height of each of the sheet materials 10 and greater than 70% of the height of each of the sheet materials 10; then, the honeycomb core 1 is pressed and conveyed through the auxiliary region, whose height is smaller than the height of the feed region; finally, to turn the honeycomb core 1 into a buffer, the honeycomb core 1 is pressed and conveyed through the output region, whose height is smaller than the height of the auxiliary region but greater than 60% of the height of each of the sheet materials 10. The height of the feed region is configured to be 90-95% of the height of each of the sheet materials 10. The height of the auxiliary region is configured to be 80-85% of the height of each of the sheet materials 10. The height of the output region is configured to be 70-75% of the height of each of the sheet materials 10. In this embodiment, the height of each of the sheet materials 10 is 2 cm. In some embodiments, the height of the feed region may be smaller than 2 cm, but bigger than 1.4 cm. In other embodiments, the height of the feed region may be 1.8-1.9 cm. In this embodiment, the height of the feed region is 1.9 cm. In some embodiments, the height of the auxiliary region is 1.6-1.7 cm. In this embodiment, the height of the auxiliary region is 1.7 cm. In some embodiments, the height of the output region is bigger than 1.2 cm, and smaller than the height of the auxiliary region and the height of the feed region. The height of the feed region, the height of the auxiliary region, and the height of the output region show gradual reduction, but the reduction ratio of adjacent heights is not higher than 30%.

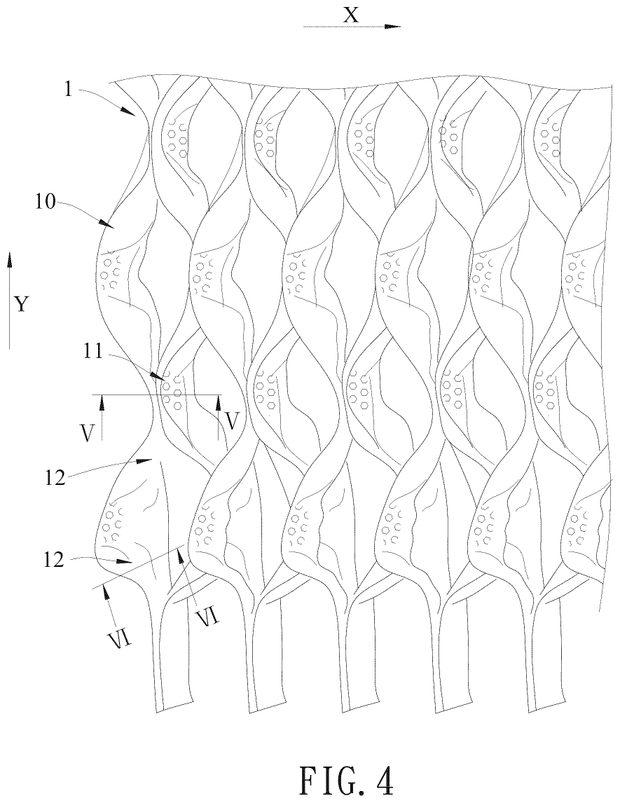

Referring to FIGS. 4 to 6, the sheet materials 10 are resilient. At the rebound stage, after the sheet materials 10 have passed through the feed region, the auxiliary region, and the output region, the bent top portions and bottom portions of the sheet materials 10 rebound and the shape of each of the sheet materials 10 is finalized. The rebounded top portions and bottom portions of the sheet materials 10 have the stiffness that maintains the structure of the honeycomb core 1. An average height of the rebounded sheet materials 10 is substantially 1.6-1.8 cm, which is substantially 80-90% of the original height of each of the sheet materials 10. For each of the hexagonal honeycomb bodies, each of the thick surrounding walls 15 has two folds 17 that are formed by respectively bending the top portions and the bottom portions of the sheet materials 10, and the folds 17 extend from two opposite ends of the intermediate portion 13. Each of the unbonded portions 12 has two folds 17 that are formed by respectively bending the top portions and the bottom portions of the sheet materials 10. It should be noted that a size of each of the folds 17 of the thick surrounding walls 15 and a size of each of the folds 17 of the unbonded portions 12 will not be significantly different due to the discrepancy in stiffness. The average deformation degree of the intermediate portions 13 of the honeycomb core 1 is less than 10% of that of the intermediate portions 13 of the honeycomb core 1 that has not been pressed and conveyed through the feed stage, the shaping stage and the rebound stage. Each of the unbonded portions 12 further has a thin surrounding wall 14 disposed between the folds 17. The folds 17 of each of the thick surrounding walls 15 in the height direction (Z) have an average length of 0.1-0.3 cm. The folds 17 of each of the unbonded portions 12 in the height direction (Z) have an average length of 0.1-0.3 cm. For each of the thick surrounding walls 15, a sum of the lengths of the folds 17 is 10-30% of the height of each of the sheet materials 10. For each of the unbonded portions 12, a sum of the lengths of the folds 17 is 10-30% of the height of each of the sheet materials 10. For each of the thick surrounding walls 15, each of the folds 17 is bent at a fold angle relative to the intermediate portion 13. For each of the unbonded portions 12, each of the folds 17 is bent at a fold angle relative to the thin surrounding wall 14. The fold angles of both the thick surrounding walls 15 and the unbonded portions 12 are affected by the process of pressing and conveying the honeycomb core 1 and the rebound process of the sheet materials 10 at the rebound stage. It should be noted that, for each of the thick surrounding walls 15, the folds 17 are not co-planar with the intermediate portion 13, and for each of the unbonded portions 12, the folds 17 are not co-planar with the thin surrounding wall 14. After the honeycomb core 1 is pressed and conveyed by the at least two friction wheel sets 21, the top portions and the bottom portions of the sheet materials 10 rebound, and a top surface and a bottom surface of the honeycomb core 1 is substantially smooth.

A buffer formed by the buffer forming machine of the disclosure is made by continuously pressing and conveying a honeycomb core 1 in the stretching direction (X) through the roller unit 2. The honeycomb core 1 includes a plurality of sheet materials 10 that are elongated in the widthwise direction (Y). Each of the sheet materials 10 has a plurality of bonded portions 11 and a plurality of unbonded portions 12 that are alternately arranged in the widthwise direction (Y). For each three adjacent ones of the sheet materials 10, the bonded portions 11 of the middle sheet material 10 are alternately bonded to the bonded portions 11 of another sheet material 10 and the bonded portions 11 of the remaining sheet material 10. Each junction of two bonded portions 11 of two adjacent ones of the sheet materials 10 forms a thick surrounding wall 15. For every two adjacent ones of the sheet materials 10, the thick surrounding walls 15 and the unbonded portions 12 form a plurality of hexagonal honeycomb bodies. Each of the hexagonal honeycomb bodies consists of four unbonded portions 12 that have the same size in the widthwise direction (Y) and that are configured as four faces of the hexagonal honeycomb body, and two thick surrounding walls 15 that have the same size in the widthwise direction (Y) and that are configured as another two faces of the hexagonal honeycomb body. In some embodiments, the size of each of the thick surrounding walls 15 in the widthwise direction (Y) is no bigger than 60% of the size of each of the unbonded portions 12 in the widthwise direction (Y). In this embodiment, the size of each of the thick surrounding walls 15 in the widthwise direction (Y) is 10-45% of the size of each of the unbonded portions 12 in the widthwise direction (Y). For each of the sheet materials 10, the folds 17 of the thick surrounding walls 15 and the folds 17 of the unbonded portions 12 are continuous. For each of the thick surrounding walls 15, a sum of the lengths of the folds 17 is 10-30% of the height of each of the sheet materials 10. For each of the unbonded portions 12, a sum of the lengths of the folds 17 is 10-30% of the height of each of the sheet materials 10. The average deformation degree of the intermediate portions 13 of the honeycomb core 1 is less than 10% of that of the intermediate portions 13 of the honeycomb core 1 that has not been pressed and conveyed through the feed stage, the shaping stage and the rebound stage. The folds 17 keep the honeycomb core 1 in an expanded state. Referring to FIG. 5, each of the thick surrounding walls 15 further has two embossed portions 16 respectively formed on the folds 17. The embossed portions 16 are formed simultaneously with the folds 17 of the thick surrounding walls 15 when the honeycomb core 1 is pressed and conveyed through the roller unit 2. The embossed portions 16 stabilize the structure of the thick surrounding walls 15 after the rebound stage.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A buffer forming machine adapted for continuously pressing and conveying a honeycomb core in a stretching direction through a feed stage, a shaping stage and a rebound stage to turn the honeycomb core into a buffer, the honeycomb core including a plurality of sheet materials that are elongated in a widthwise direction perpendicular to the stretching direction, and that are arranged in the stretching direction, each of the plurality of sheet materials having a plurality of bonded portions and a plurality of unbonded portions that are alternately arranged in the widthwise direction, wherein, for each three adjacent ones of the plurality of sheet materials, the plurality of bonded portions of the middle sheet material are alternately bonded to the plurality of bonded portions of another sheet material and the plurality of bonded portions of the remaining sheet material, each junction of two bonded portions of two adjacent ones of the plurality of sheet materials forming a thick surrounding wall, said buffer forming machine comprising:
a frame;
a roller unit that is mounted to said frame, and that includes at least two friction wheel sets spaced apart from each other in the stretching direction, one of said at least two friction wheel sets including a first upper rolling friction wheel and a first lower rolling friction wheel that are arranged in a height direction perpendicular to the widthwise direction and the stretching direction, said first upper rolling friction wheel and said first lower rolling friction wheel cooperatively defining a feed region therebetween, another one of said at least two friction wheel sets including a second upper rolling friction wheel and a second lower rolling friction wheel that are arranged in the height direction, said second upper rolling friction wheel and said second lower rolling friction wheel cooperatively defining an output region therebetween;
wherein, a ratio of a height of said output region in the height direction to a height of said feed region in the height direction is greater than 70%, said height of said feed region in the height direction being configured to be 90-95% of a height of each of the plurality of sheet materials in the height direction, said height of said output region in the height direction being configured to be 70-75% of the height of each of the plurality of the sheet materials.

2. The buffer forming machine as claimed in claim 1, further comprising:
a feeder unit that is mounted to said frame, that is disposed upstream of said roller unit in the stretching direction, and that includes
a rotary wheel, and
a plurality of levers mounted to said rotary wheel and spaced apart from each other;
wherein, when said rotary wheel and said plurality of levers are driven to rotate, each of said plurality of levers is adapted to be inserted between a corresponding adjacent pair of the plurality of sheet materials to draw the honeycomb core in the stretching direction into said roller unit for said roller unit to conduct pressing and conveying of the honeycomb core.

3. The buffer forming machine as claimed in claim 2, wherein:
said roller unit further includes
an auxiliary upper rolling friction wheel disposed between said first upper rolling friction wheel and said second upper rolling friction wheel, and
an auxiliary lower rolling friction wheel disposed between said first lower rolling friction wheel and said second lower rolling friction wheel, said auxiliary upper rolling friction wheel and said auxiliary lower rolling friction wheel being arranged in the height direction, said auxiliary upper rolling friction wheel and said auxiliary lower rolling friction wheel cooperatively defining an auxiliary region therebetween; and
a height of said auxiliary region in the height direction is smaller than said height of said feed region and larger than said height of said output region.

4. The buffer forming machine as claimed in claim 3, wherein:
said height of said auxiliary region in the height direction is configured to be 80-85% of the height of each of the plurality of the sheet materials.

5. The buffer forming machine as claimed in claim 1, further comprising a driver unit that is mounted to said frame, said driver unit being operable for driving said at least two friction wheel sets and said rotary wheel to rotate.
